(19) United States
(12) Patent Application Publication
(10) Pub. No.: US 2015/0151510 A1
(43) Pub. Date: Jun. 4, 2015

(54) COMPOSITE HEAT AND FLAME BARRIER

(71) Applicants: ZOLTEK COMPANIES, INC., St. Louis, MO (US); ALBARRIE CANADA LIMITED, Barrie (CA)

(72) Inventors: Alan HANDERMANN, Asheville, NC (US); Peter KUZIW, Barrie (CA)

(21) Appl. No.: 14/560,112

(22) Filed: Dec. 4, 2014

Related U.S. Application Data
(60) Provisional application No. 61/911,681, filed on Dec. 4, 2013.

(51) Int. Cl. B32B 5/26; B32B 27/12; F16L 59/02; B32B 15/14; B32B 5/02; B32B 13/14

(52) U.S. Cl. CPC B32B 5/26; B32B 5/022; B32B 13/14; F16L 59/029; B32B 15/14; B32B 27/12; B32B 2255/02; B32B 2255/24; B32B 2307/3065

(57) ABSTRACT

A composite flame barrier includes at least two layers of nonwoven flame resistant fibers, and at least one active chemical layer including a heat absorbing intumescent or endothermic compound, the active chemical layer being mechanically bound to and at least partially embedded within the nonwoven fiber layers. The composite flame barrier is particularly useful in applications that require a flexible, extended time fire barrier. Such applications include, for example, fuel line, process pipeline and valve protection when transporting combustible liquids; structural steel fireproofing, electrical cable wrap and fire-rated wall assemblies, especially those requiring two, three and four hour fire-ratings, when tested according to ASTM E-119 or similar testing methods and standards.

This application claims the benefit under 35 U.S.C. §119(e) to U.S. Provisional Application No. 61/911,681 filed on Dec. 4, 2013. The application is incorporated herein by reference in its entirety.

### TECHNICAL FIELD

The present invention is directed to a composite flame barrier that is particularly useful in applications that require a flexible, extended time fire barrier. Such applications include, for example, fuel line, process pipeline and valve protection when transporting combustible liquids; structural steel fireproofing, electrical cable wrap and fire-rated wall assemblies, especially those requiring two, three and four hour fire-ratings, when tested according to ASTM E-119 or similar testing methods and standards

### BACKGROUND

Fire-rated wall construction assemblies are commonly used in the construction industry. Such assemblies are aimed at preventing fire, heat, and smoke from traveling from one section of a building to another. The assemblies often incorporate the use of some type of fire-retardant material that substantially blocks the path of the fire, heat, and smoke for at least some period of time. The fire-retardant material may include fibers or fibrous fabrics, the fibers typically made of ceramic material, fiberglass or other inorganic fibers.

Conventional flame barriers typically include organic or resinous binders to bind intumescent materials and/or endothermic materials to a fibrous substrate. One disadvantage of including organic polymeric binders or resins is that these materials burn and generated smoke and objectionable gases when exposed to direct flame. Another disadvantage of conventional flame barriers is that the organic binders and resins cause the fire barrier product to lose its integrity upon flame exposure, and become very brittle.

Commercially available wall assemblies include those made of stressed skin sandwich panels that include steel, aluminum or fiberglass reinforced polyester facings bonded to a volcanic rock mineral fiber with a heat polymerizing adhesive. Such insulating panels require extremely thick walls (e.g., 16 inches thick) in order to achieve a three hour fire wall rating.

Other commercially available wall assemblies include insulation boards made of mineral wool insulation. To achieve a three hour fire wall rating, a 4 inch thick layer of this insulation board must be compressed to fit within a 3.5 inch steel stud cavity, which requires a very labor and material intensive installation process. Moreover, working with mineral wool insulation may cause worker irritation and potentially negative inhalation health effects.

### SUMMARY

The present invention is directed to a composite flame barrier that is particularly useful in applications that require a flexible, extended time fire barrier. Such applications include, for example, fuel line, process pipeline and valve protection when transporting combustible liquids; structural steel fireproofing, electrical cable wrap and fire-rated wall assemblies, especially those requiring two, three and four hour fire-ratings, when tested according to ASTM E-119 or similar testing methods and standards.

The composite flame barrier of the present invention does not contain polymeric binders and includes at least one active chemical layer mechanically contained between and within at least two layers of nonwoven textile material. In a preferred embodiment, the composite flame barrier includes two active chemical layers mechanically contained between and within at least three layers of nonwoven textile material. The one or more active chemical layers may be mechanically incorporated into the composite flame barrier through a needlepunching process.

In a first aspect of the invention there is provided a composite that includes at least two fiber sheets, each sheet including flame resistant fibers; and at least one active chemical layers, present between the fiber sheets; wherein the fiber sheets are mechanically bonded to contain the active chemical between the fiber sheets.

In a second aspect of the invention, there is provided a composite that includes at least three fiber sheets, each sheet including flame resistant fibers; and at least two active chemical layers, present between the fiber sheets; wherein the fiber sheets are mechanically bonded to contain the active chemical between the fiber sheets.

The composite may be a flame barrier or a heat barrier.

In one embodiment, the flame resistant fibers of the composite flame barrier include oxidized polyacrylonitrile fibers.

In one embodiment, fiber sheets are nonwoven fiber sheets.

In one embodiment, the fiber sheet further includes flame resistant fibers of a second type. The second type of flame resistant fibers may be chosen from among meta-aramids, para-aramids, poly(diphenylether para-aramid), polybenzimidazole, polyimides, polyamideimides, novoloids, poly(p-phenylene benzobisoxazoles), poly(p-phenylene benzothiazoles), flame retardant viscose rayon, polyetheretherketones, polyketones, polyetherimides, and combinations thereof.

In one embodiment, the fiber sheet further includes high temperature reinforcing fibers chosen from among glass fiber, mineral fiber, ceramic fiber, carbon fiber, stainless steel fiber and combinations thereof.

In one embodiment, the active chemical layer or layers include a heat absorbing intumescent or endothermic compound. The endothermic compound may include a mineral hydrate material chosen from among aluminum sulfate hexadecahydrate, alumina trihydrate, aluminum potassium sulfate dodecahydrate, magnesium sulfate heptahydrate, magnesium chloride hexahydrate, sodium tetraborate decahydrate and combinations thereof.

In one embodiment, the fiber sheet further includes a low temperature resistant fiber type chosen from among wood pulp types, hemps, flax, cottons, wools, nylons, polyesters, polyolefins, rayons, acrylics, silks, mohair, cellulose acetate, polylactides, lyocell, and combinations thereof.

In one embodiment, the composite further includes a reinforcing layer.

In one embodiment, the composite further includes an outer laminar material. The outer laminar material may be a polymeric film, for example, a polymeric film chosen from among polyesters, polyethylenes, polypropylenes, polyvinyl chlorides, polyvinyl alcohols and combinations thereof.

In one embodiment, the outer laminar material may include a metal foil.

In one embodiment, the outer laminar material may include paper.

The fiber sheets of the composite may be mechanically bonded by needlepunching, quilting or stitchbonding. In one embodiment, the fiber sheets are mechanically bonded by needlepunching.

In one embodiment, the composite is substantially free of organic binder and resin materials.

In one embodiment, the composite has a fire rating of 1 hr, 1.5 hr, 2 hr, 2.5 hr, 3 hr and 4 hr when tested according to ASTM E-119.

In one aspect of the invention, there is provided a gypsum wallboard installation that includes a composite that includes at least two fiber sheets, each sheet including flame resistant fibers; and at least one active chemical layers, present between the fiber sheets; wherein the fiber sheets are mechanically bonded to contain the active chemical between the fiber sheets.

In one aspect of the invention, there is provided a process for making a composite flame barrier, the process including the steps of: providing a first nonwoven textile sheet, the nonwoven textile sheet including flame resistant fibers; depositing an active chemical layer of at least one heat absorbing or endothermic compound onto the first nonwoven textile sheet; overlaying a second nonwoven textile sheet onto the active chemical layer, the second nonwoven textile sheet including flame resistant fibers; and mechanically bonding the first and second nonwoven textile sheets together; wherein the active chemical layer is mechanically contained within the first and second nonwoven textile sheets.

In another aspect of the invention, there is provided a process for making a composite flame barrier, the process including the steps of: providing a first nonwoven textile sheet, the nonwoven textile sheet including flame resistant fibers; depositing a first active chemical layer of at least one heat absorbing or endothermic compound onto the first nonwoven textile sheet; overlaying a second, intermediate nonwoven textile sheet onto the first active chemical layer, the intermediate nonwoven textile sheet including flame resistant fibers; depositing a second active chemical layer of at least one heat absorbing or endothermic compound onto the second, intermediate textile sheet; overlaying a third nonwoven textile sheet onto the second active chemical layer, the third nonwoven textile sheet including flame resistant fibers; and mechanically bonding the first, second and third nonwoven textile sheets together; wherein the first and second active chemical layers are mechanically contained within the first, second and third nonwoven textile sheets.

In one embodiment of the process, the flame resistant fibers of the nonwoven textile sheets include oxidized polyacrylonitrile fibers.

In one embodiment of the process, the first and second active chemical layers include a mineral hydrate material chosen from among aluminum sulfate hexadecahydrate, alumina trihydrate, aluminum potassium sulfate dodecahydrate, magnesium sulfate heptahydrate, magnesium chloride hexahydrate, sodium tetraborate decahydrate and combinations thereof.

In one embodiment of the process, the fiber sheets are mechanically bonded by needlepunching.

### BRIEF DESCRIPTION OF THE DRAWINGS

FIG. 1 is a partial cross-sectional view of an embodiment of the composite flame barrier according to the present invention.

FIG. 2 is a partial cross-sectional view of an alternative embodiment of the composite flame barrier that includes two nonwoven textile layers in accordance with the present invention.

FIG. 3 is a partial cross-sectional view of an embodiment of the composite flame barrier of FIG. 1 further including a reinforcement layer in accordance with the present invention.

FIG. 4 is a partial cross-sectional view of an embodiment of the composite flame barrier of FIG. 1 further including an outer laminar layer in accordance with the present invention.

FIG. 5 is a partial cross-sectional view of an embodiment of the composite flame barrier of FIG. 1 further including an outer laminar layer overlying a reinforcement layer in accordance with the present invention.

### DETAILED DESCRIPTION

The present invention provides a composite flame barrier which, when tested according to standard flame resistance test methods such as American Standard Testing Method E-119, allows for longer fire-rated wall assemblies, with fewer gypsum wallboard layers, and less installation labor time and materials to form a thinner fire-rated wall assemblies. The composite flame barrier provides a strong fire resistant layer and also slows down the transmission of heat by exhibiting a significant endothermic cooling effect, when the mineral hydrate materials of the active chemical layer release their chemically bound water.

Since the composite flame barrier of the present invention is very flexible and lightweight, it is easily handled and installed in construction projects that require fire-rated wall assemblies. This provides more architectural design freedom by allowing thinner, easier to form wall assemblies to be constructed, while still meeting the fire-rated test requirements of the installation.

In accordance with an embodiment of the present invention, there is provided a composite flame barrier that includes at least two nonwoven textile layers of flame resistant fibers; and at least one active chemical layer mechanically contained between and within the nonwoven textile layers. Preferably, the flame resistant fibers of the nonwoven textile layers include oxidized polyacrylonitrile (OPAN) flame resistant fibers

The composite flame barrier of the present invention can be made at a substantially lower areal weight and achieve better cooling capabilities than conventional flame barriers, which have a substantially heavier areal weight and contain polymeric binders.

The term “overlies” and cognate terms such as “overlying” and the like, when referring to the relationship of one or a first layer relative to another or a second layer, refers to the fact that the first layer partially or completely lies over the second layer. The first layer overlying the second layer may or may not be in contact with the second layer. For example, one or more additional layers may be positioned between the first layer and the second layer. The term “underlies” and cognate terms such as “underlying” and the like have similar meanings except that the first layer partially or completely lies under, rather than over, the second layer.

The term “outer” refers to the position of a layer as being farther from the center of the composite assembly, but does not necessarily mean such layer is the outermost layer.

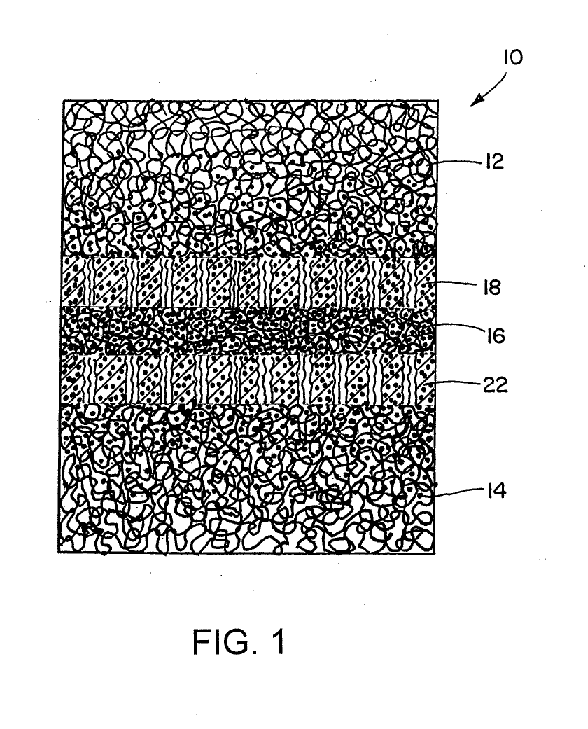

Referring to FIG. 1, in one embodiment the composite flame barrier 10 includes three nonwoven textile layers constructed of flame resistant fibers, a first nonwoven textile layer 12, a second nonwoven textile layer 14, and a third intermediate nonwoven textile layer 16 between the first and second textile layers. Preferably, the flame resistant fibers include OPAN fibers. Between the first textile layer 12 and the intermediate textile layer 16 is a first active chemical layer 18. Between the second textile layer 14 and the intermediate textile layer 16 is a second active chemical layer 22. The two active chemical layers are mechanically contained between and within the nonwoven textile layers.

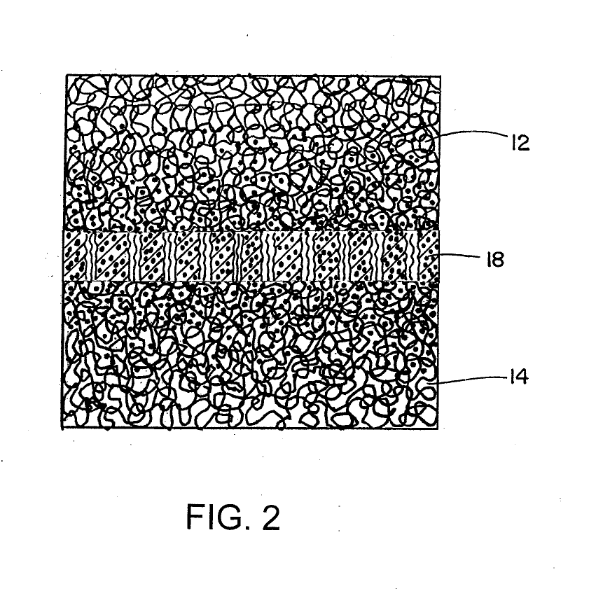

In an alternative embodiment, illustrated in FIG. 2, the composite flame barrier 10 includes two nonwoven textile layers constructed of flame resistant fibers, a first nonwoven textile layer 12 and a second nonwoven textile layer 14. Preferably, the flame resistant fibers include OPAN fibers. Between the first textile layer 12 and the second textile layer 14 is a single active chemical layer 18. The active chemical layer is mechanically contained between and within the nonwoven textile layers.

The layers of the composite flame barrier are needled together to interlock the fibers in the nonwoven layers around the active chemical particles between and within the nonwoven layers, making a unitary barrier material.

Surprisingly, it has been found that incorporating an intermediate layer of nonwoven textile fabric and incorporating two active chemical layers, not only allows better mechanical containment of the active chemical within the fire barrier, but also improves the thermal efficiency of resulting barrier; as compared to incorporating one thicker layer of active chemical between two nonwoven textile fabrics. The ability to mechanically contain the active chemical within the composite flame barrier, and the burn performance of the fire barrier, are enhanced by incorporating an intermediate nonwoven textile layer.

### Nonwoven Textile Layer

In one embodiment, the nonwoven textile layers (12, 14, 16) may each be made of 100% by weight of oxidized polyacrylonitrile (OPAN) fibers. As used herein, the term “nonwoven textile” is intended to include sheet or web structures bonded together by entangling fibers mechanically, thermally or chemically, and are not woven or knitted. Preferred nonwoven textiles include needlepunched sheets or webs. A particularly preferred OPAN fiber is that which is commercially available under the trade name PYRON® from Zoltek Corporation.

In another embodiment, one or more of the nonwoven textile layers (12, 14,16) may include flame resistant fibers of a second type. Examples of other flame resistant fibers that can be incorporated into the nonwoven textile layer(s) include meta-aramids such as poly(m-phenylene isophthalamide), for example, those sold under the trade names NOMEX by E. I. Du Pont de Nemours and Co., TEIJINCONEX by Teijin Limited, ARAMID 1313 by Guangdong Charming Chemical Co. Ltd., etc.; para-aramids such as poly(p-phenylene terephthalamide), for example, that are sold under the trade name KEVLAR by E. I. Du Pont de Nemours and Co., poly(diphenylether para-aramid), for example, that are sold under the trade name TECHNORA by Teijin Limited, and those sold under the trade name TWARON by Teijin Limited, etc.; polybenzimidazole such as that sold under the trade name PBI by PBI Performance Products, Inc.; polyimides, for example, those sold under the trade names P-84 by Evonik Industries; polyamideimides, for example, that are sold under the trade name KERMEL by Kermel; novoloids, for example, phenol-formaldehyde novolac, that are sold under the trade name KYNOL by Gun Ei Chemical Industry Co.; poly(p-phenylene benzobisoxazole) (PBO), for example, that are sold under the trade name ZYLON by Toyobo Co.; poly(p-phenylene benzothiazoles) (PBT); polyphenylene sulfide (PPS), for example, those sold under the trade names RYTON by Chevron Phillips Chemical Company LLC, TORAY PPS by Toray Industries Inc., FORTRON by Kureha Chemical Industry Co. and PROCON by Toyobo Co.; flame retardant viscose rayons, for example, those sold under the trade names LENZING FR by Lenzing A.G. and AVILON by Avilon Oy Finland; polyetheretherketones (PEEK), for example, that are sold under the trade name ZYEX by Zyex Ltd.; polyketones (PEK); polyetherimides (PEI), for example, that are sold under the trade name ULTEM by Fiber Innovation Technologies Inc., and fiber combinations thereof.

The composite flame barrier may include high temperature reinforcing fibers to impart additional mechanical strength to the composite flame barrier. For example, the composite flame barrier can also include glass fibers, mineral fibers such as basalts, for example, those sold under the trade name BASFIBER® by Kamenny Vek, basalt fiber by Technobasalt-Invest LLC, basalt fiber by Sudaglass Fiber Technology, etc.; ceramic fibers, for example, those sold under the trade name BELCOTEX® by BelChem, CERATEX® by Mineral Seal Corporation, FIBERFRAX® by Unifrax I LLC, KAOWOOL® by Thermal Ceramics Inc., etc.; carbon fibers, stainless steel fibers or other similar high temperature reinforcing fibers. The high temperature reinforcing fibers may be incorporated into the nonwoven or woven fiber sheet material.

For applications that do not require the high flame resistance that results with using nonwoven textile layers of 100% oxidized polyacrylonitrile fiber, the composite flame barrier can also include low temperature synthetic or natural fibers within the nonwoven textile sheets. Such low temperature fibers may be selected from a variety of different types of either natural or synthetic fibers. Examples of low temperature fibers include wood pulp types, hemps, flax, cottons, wools, nylons, polyesters, polyolefins, rayons, acrylics, silks, mohair, cellulose acetate, polylactides, lyocell, and combinations thereof.

### Active Chemical Layer

The active chemical layer of the fire barrier composite is mechanically contained between and within the adjacent nonwoven textile layers to impart additional fire resistance to the composite flame barrier. The composite flame barrier of the present invention does not contain polymeric binders to bind the active chemicals within the nonwoven textile layers.

The active chemical of the active chemical layer may include an endothermic compound such as a mineral hydrate material that provides an endothermic water release under heating and burning conditions to provide additional heat and flame protection by slowing down heat transmission. The term “mineral hydrate” refers to mineral crystals containing water molecules combined in a definite molar ratio. The mineral hydrate may be in the form of powders, granules or crystals. Examples of suitable mineral hydrates include aluminum trihydrate, aluminum potassium sulfate dodecahydrate, magnesium hydroxide, magnesium bromate hexahydrate, magnesium sulfate heptahydrate, magnesium iodate tetrahydrate, magnesium antimonate hydrate, magnesium chloride hexahydrate, calcium ditartrate tetrahydrate, calcium chromate dihydrate, sodium tetraborate decahydrate, sodium thiosulfate pentahydrate, sodium pyrophosphate hydrate, potassium ruthenate hydrate, potassium sodium tartrate tetrahydrate, zinc iodate dihydrate, zinc sulfate heptahydrate, zinc phenol sulfonate octahydrate, manganese chloride tetrahydrate, cobalt orthophosphate octahydrate, beryllium oxalate trihydrate, zirconium chloride octahydrate, thorium hypo phosphate hydrate, thallium sulfate heptahydrate, dysprosium sulfate octahydrate, and combinations of two or more thereof. Particularly useful mineral hydrates include alumina trihydrate, aluminum sulfate hexadecahydrate, aluminum potassium sulfate dodecahydrate, magnesium sulfate heptahydrate, magnesium chloride hexahydrate, and sodium tetraborate decahydrate, and combinations of two of more thereof.

Other endothermic compounds include compounds that absorb heat by going through a phase change that absorbs heat (i.e., liquid to gas), or by other chemical change, such as thermal decomposition, with the evolution of one or more small molecules such as ammonia, carbon dioxide, and/or water, to provide a net uptake of thermal energy.

The active chemical layer may further include one or more intumescent materials. As used herein, the term “intumescent material” refers to a compound that expands to at least 1.5 times its original volume upon exposure to high surface temperatures or flames, for example exposure to temperatures above 100° C. Examples of intumescent materials include hydrated alkali metal silicates, graphite such as intercalated graphite and acid treated graphite, vermiculite, perlite, NaBSi and mica.

### Additional Layers

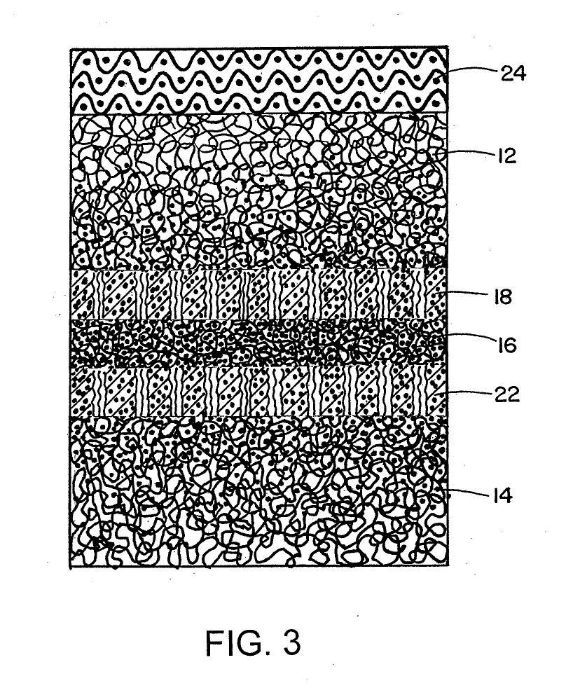

Referring to FIG. 3, the composite flame barrier may include a reinforcing layer 24 overlying the outer surface of one or both of the nonwoven textile layers 12 and 14. The reinforcing layer 24 may be attached to the nonwoven textile layer 12 through chemical, thermal or mechanical bonding to improve dimensional stability and tensile strength of the flame barrier. The reinforcing layer may be a woven fabric scrim made from the same or different synthetic fibers as the nonwoven textile layer. Alternatively, the reinforcing layer 24 can be made from inorganic fibers, woven or knit from monofilament, multifilament, spun yarns or rovings. The reinforcing layer 24 may be a woven high temperature reinforcement material constructed of glass; ceramic; carbon; mineral, such as basalt; metal, such as stainless steel; flame resistant polymers, such those listed above; and combinations of two or more thereof. In one embodiment, the reinforcing layer is a high strength fiberglass scrim.

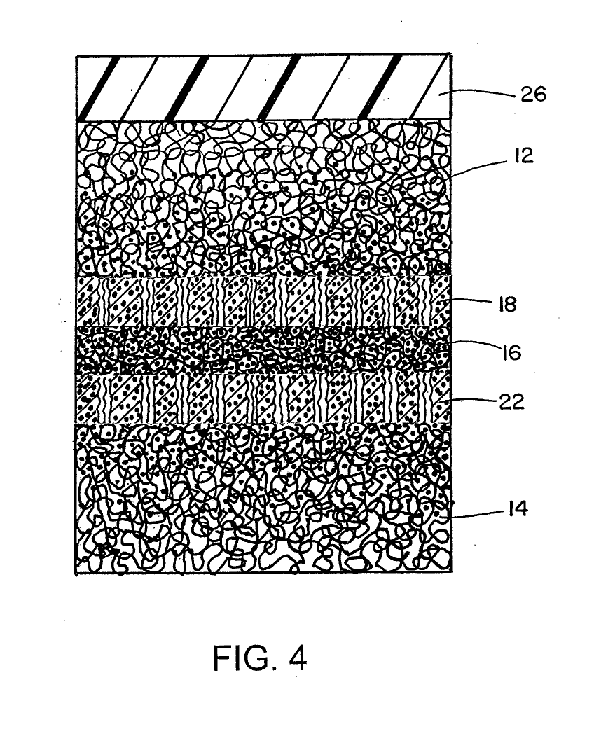

Referring to FIG. 4, the composite flame barrier may include an outer laminar layer 26 overlying nonwoven textile layer 12 or underlying nonwoven textile layer 14. The laminar layer 26 may be a coated paper, a polymeric film, or a metallic foil. Examples of useful polymeric films include polyesters, polyethylenes, polypropylenes, polyvinyl chlorides, polyvinyl alcohols and combinations thereof. A laminar layer 26 may be bonded to the outer surface of one or both of nonwoven textile layers 12 and 14, for example, by lamination.

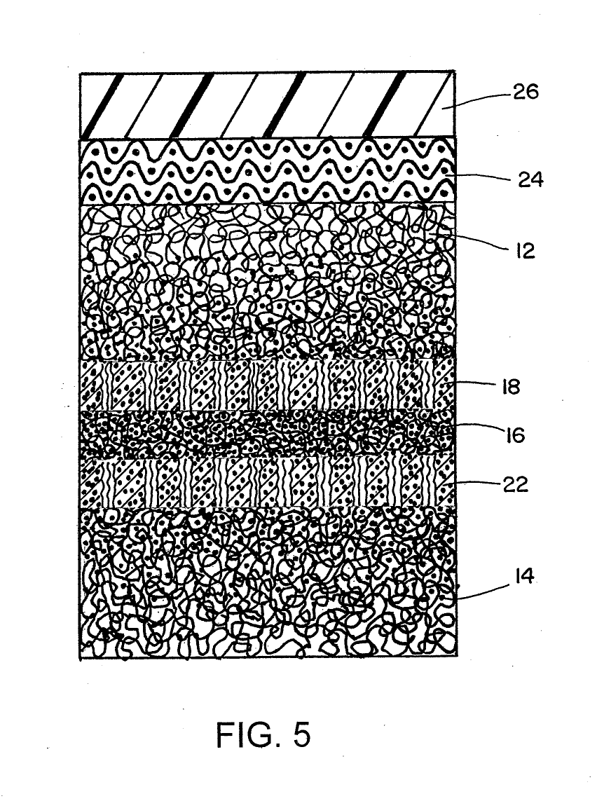

Referring to FIG. 5, one or both of the outermost layers of the composite flame barrier may be covered with a laminar material. Laminar layer 26 may be bonded to an outer surface of the reinforcement layer 24.

In one embodiment of the invention, the composite flame barrier includes two layers of 10-2000 g/m² nonwoven textile layers of oxidized polyacrylonitrile (OPAN) fiber, or preferably two layers of 100-1000 g/m² nonwoven textile layers of OPAN fiber as top and bottom layers; and a single 5-1000 g/m² nonwoven textile layer of OPAN fiber as an intermediate layer. Two 100-5000 g/m² layers of mineral hydrate, or preferably two 200-2500 g/m² layers of mineral hydrate, are mechanically contained between and within the three layers of nonwoven textile material.

In one embodiment of the invention, a five layer barrier (substrate textile layer, first mineral hydrate layer, intermediate textile layer, second mineral hydrate layer and cover textile layer) is produced by placing a roll of a nonwoven textile fabric on a reel and guiding the fabric into a needling loom as a substrate (i.e., bottom) layer. A first predetermined amount of a mineral hydrate is fed by means of a first dispensing unit onto the top of the moving substrate, forming a continuous active chemical layer of predetermined density and thickness on top of the substrate. The active chemical layer is then covered with an intermediate nonwoven textile layer dispensed from another reel. A second predetermined amount of mineral hydrate is fed by means of a second dispensing system onto the top of the moving intermediate textile layer to form a second active chemical layer. The second active chemical layer is then covered with a final nonwoven textile layer, also dispensed from a reel.

The intermediate layer can be a nonwoven fabric produced from synthetic fibers having a total thickness from 0.1 mm to 15 mm and having an areal weight in the range from 10 g/m² to 1,000 g/m². The nonwoven fabric can be mechanically bonded, needlepunched, spunlaid, airlaid, or obtained in any other technological process. The intermediate textile layer should be dense enough to provide proper separation of the mineral hydrate layers. The selection of the intermediate layer should be based on particle size of the mineral hydrate. In one embodiment, the intermediate layer has an average pore size of less than 100 micrometers.

The needlepunching process causes many individual fibers of the nonwoven textile layers to extend through the layers of the mineral hydrate and to anchor into the substrate and/or the intermediate layer. Fibers extending from the top nonwoven textile layer and anchoring into the bottom nonwoven textile layer form strong mechanical bonds between the layers, interlocking the mineral hydrate between the all of the textile layers.

The mechanical bond formed by fibers from the top layer interlocking, through the needling process, with the fibers of the bottom layer provide a counteracting action against the expansion and loss of the mineral hydrate, when exposed to heat or fire. Strong and permanent mechanical containment of the mineral hydrate, between layers of textile material, is an essential component of the invention.

After the needlepunching process, a roll of the final assembled product is collected at the exit of the needling loom.

Multilayered textile structures, containing additional layers, can be created by including more intermediate layers either as part of the initial process or in subsequent add-on processes.

In another process embodiment, it is possible to use a needling operation where needles enter the fabric from both the top and the bottom major surfaces. In this embodiment, the needling is performed from top to bottom and from bottom to top, either simultaneously or in separate stages of the needling process.

The following non-limiting examples are set forth to demonstrate the present invention.

### Examples 1-5

### Composite Flame Barriers

Composite flame barriers were made by first forming three separate needlepunched nonwoven felts of 100% PYRON® oxidized polyacrylonitrile (OPAN) staple fibers. The top and substrate layers had basis weights of 608 gsm and the intermediate layer had a basis weight of 195 gsm. A first powder applicator was used to evenly distribute the first layer of the mineral hydrate materials listed in Table 1, onto the surface of the 608 gsm needlepunched nonwoven substrate layer. The 195 gsm needlepunched intermediate layer was applied over the first mineral hydrate layer and a second powder applicator was used to evenly distribute a second layer of mineral hydrate material (listed in Table 1) onto the surface of the 1950 gsm needlepunched intermediate layer. Finally, a top 608 gsm layer of 100% PYRON® oxidized polyacrylonitrile OPAN felt was applied over the surface of the second mineral hydrate layer. The entire composite assembly was needlepunched, causing the fibers in each of the three nonwoven fabric layers to anchor into each other, mechanically containing the mineral hydrate layers between and within the nonwoven layers to form the composite flame barrier.

TABLE 1

| | 1 | | 2 | | 3 | | 4 | | 5 | |
|---|---|---|---|---|---|---|---|---|---|---|
| | 1st | 2nd | 1st | 2nd | 1st | 2nd | 1st | 2nd | 1st | 2nd |
| FLAME BARRIER NUMBER | Layer | Layer | Layer | Layer | Layer | Layer | Layer | Layer | Layer | Layer |
| MINERAL HYDRATE TYPE | gsm | gsm | gsm | gsm | gsm | gsm | gsm | gsm | gsm | gsm |
| Sodium Tetraborate Decahydrate | | | | | 716 | 716 | 591 | 591 | | |
| Alumina Trihydrate | | | | | 591 | 591 | 1141 | 1141 | | |
| Aluminum Sulfate Hexadecahydrate | | | 1168 | 1168 | 716 | 716 | | | 1141 | 1141 |
| Magnesium Sulfate Heptahydrate | 1086 | 1086 | | | | | | | | |

| | | | | | |
|---|---|---|---|---|---|
| Total Mineral Hydrate Weight | 2172 | 2336 | 2864 | 2364 | 4564 |
| Total Composite Flame Barrier Weight | 3583 | 3747 | 4275 | 3775 | 5975 |

### Examples 6-9

### Composite Flame Barriers

Composite flame barriers were made by first forming two separate needlepunched nonwoven felts of 100% PYRON® oxidized polyacrylonitrile (OPAN) staple fibers. The top and substrate layers had basis weights of 608 gsm. A first powder applicator was used to evenly distribute one layer of mineral hydrate material, (listed in Table 2) onto the surface of the 608 gsm needlepunched nonwoven substrate layer. A top 608 gsm layer of 100% PYRON® oxidized polyacrylonitrile (OPAN) felt was applied over the surface of the mineral hydrate layer. The composite assembly was needlepunched to form a composite flame barrier.

TABLE 2

| | FLAME BARRIER NUMBER | | | |
|---|---|---|---|---|
| | 6 | 7 | 8 | 9 |
| | One | One | One | One |
| | Layer | Layer | Layer | Layer |
| MINERAL HYDRATE TYPE | gsm | gsm | gsm | gsm |
| Sodium Tetraborate Decahydrate | | | 1720 | 2188 |
| Alumina Trihydrate | | | | 2188 |
| Aluminum Sulfate Hexadecahydrate | | 3902 | 1720 | |
| Magnesium Sulfate Heptahydrate | 4074 | | | |
| Total Mineral Hydrate Weight | 4074 | 3902 | 3440 | 4376 |
| Total Composite Flame Barrier Weight | 5290 | 5118 | 4656 | 5592 |

### Comparative Example 10

### Flame Barrier

A commercially available flame barrier containing refractory ceramic fibers, alumina trihydrate and an organic polymeric binder, was also tested according to the same procedure as those inventive samples of Example 1, which is described below. This comparative barrier had a total areal weight of 8926 grams/sqm.

The five-layer composite flame barriers of Examples 1-5, along with the three-layer composite flame barriers of Examples 6-9, and the flame barrier of Comparative Example 10 were tested according to a procedure based on ASTM D7140 “Standard Test Method to Measure Heat Transfer through Textile Thermal Barrier Materials”. The samples were each placed between two steel plates with a 6″×6″ square opening. A copper disk was placed on top of the sample and the assembly was covered with a ceramic fiber board with a center hole. A thermocouple was inserted through the hole, resting on the copper disk and the temperature was recorded on a data logger, as an approximately 1200° C. flame was applied to the underside of the test sample.

The test procedure consisted of applying a ˜1200° C. flame, supplied via a 2 l/min 40 mm diameter Meker burner to the underside of a 6″×6″ barrier sample placed ½ inch above the top surface of the burner. Tests were conducted with the Meker burner on for 40 minutes, followed by a 20 minute cool down. The top “cool side” temperature was monitored and recorded throughout the test.

“Cool side” temperatures, measured at 10 minute intervals, are shown in TABLE 3 for the samples of Examples 1-9 and the comparative samples of Example 10.

TABLE 3

| | | | | | | | THERMAL |
|---|---|---|---|---|---|---|---|
| | 1200° C. | | | | | | EFFI- |
| | BURNER | | | | BURNER | | CIENCY |
| | ON | | | | OFF | | (1200° C.- |
| | 10 | 20 | 30 | 40 | 50 | 60 | 40 min ° C.)/ |
| FLAME | min | min | min | min | min | min | Barrier Wt. |
| BARRIER | ° C. | ° C. | ° C. | ° C. | ° C. | ° C. | (gsm) |
| Example 1 | 99 | 229 | 359 | 383 | 224 | 129 | 0.23 |
| Example 2 | 99 | 177 | 304 | 345 | 212 | 126 | 0.23 |
| Example 3 | 96 | 170 | 310 | 344 | 207 | 121 | 0.20 |
| Example 4 | 109 | 244 | 309 | 335 | 203 | 117 | 0.23 |
| Example 5 | 99 | 171 | 224 | 274 | 201 | 124 | 0.15 |
| Example 6 | 95 | 254 | 370 | 401 | 221 | 128 | 0.15 |
| Example 7 | 103 | 259 | 346 | 372 | 202 | 118 | 0.15 |
| Example 8 | 95 | 275 | 369 | 390 | 242 | 136 | 0.16 |
| Example 9 | 108 | 254 | 342 | 371 | 211 | 123 | 0.17 |
| Comparative | 197 | 326 | 434 | 458 | 307 | 174 | 0.08 |
| Example 10 | | | | | | | |

The test results of Table 3 clearly show the superior thermal efficiency of the flame barriers of the present invention. For purposes of comparison, thermal efficiency is defined as the temperature difference between the flame temperature (1200° C.) and the cool side temperature measured at 40 minutes into the test, divided by the total areal weight of the flame barrier sample.

The composite flame barriers of Examples 1-5 had cool side temperatures ranging 75° C.-184° C. cooler, after 40 minutes of flame exposure, as compared to the barrier sample of Comparative Example 10. The flame barriers of Examples 1-5 were also 33%-60% lighter (Table 1) than the flame barrier of Comparative Example 10; demonstrating a thermal efficiency advantage that is 1.9x-2.8x better for the inventive barriers.

Table 3 also shows as much as a 45% thermal efficiency advantage for the flame barriers of Examples 1-5, as compared to the flame barriers of Examples 6-9. Even when the thermal efficiency value of a five-layer barrier is similar to the three-layer barriers (Example 5 vs Examples 6-9); the five-layer barrier demonstrated a cool side temperature ranging 97° C.-127° C. cooler, after 40 minutes of flame exposure, as compared to the three-layer barriers of Examples 6-9.

Another advantage of the five-layer barriers of Examples 1-5, versus the three-layer barriers of Examples 6-9, is that the mineral hydrate has a higher degree of mechanical containment within the barrier. Other advantages observed during the flame testing of the flame barriers of the present invention, as compared to Comparative Example 10, is that the flame barrier of the comparative example generated a lot of smoke and objectionable combustion gases during the flame test and was very brittle and friable after the 60 minute test; unlike the fire barriers of Examples 1-9, which did not generate smoke or objectionable gases and remained strong and intact after the 60 minute test.

Another advantage of the flame barrier of the present invention, as compared to the flame barrier of Comparative Example 10, is that the flame barriers of Examples 1-9 are much more flexible, being able to be wrapped around much tighter radii, without cracking and more easily conforms to the shape of the wrapped object. The flame barriers of the present invention also have a much higher tensile strength than the flame barrier of Comparative Example 10.

Although the contemplated use of the composite flame barrier of the present invention includes flexible, extended time fire barriers in applications such as electrical cable trays, fuel line, steam and process pipeline protection, structural steel fireproofing, and fire-rated wall assemblies, it is to be understood that other end uses are intended where the endothermic cooling effect of the mineral hydrate materials, encapsulated between and within the nonwoven needlepunched flame barrier, can provide additional heat and flame protection by slowing down heat transmission. Other uses for the composite flame barrier of the present invention include, for example, fire protection for equipment shrouds, support members, electrical circuit panels, medical gas boxes and elevator call boxes.

While the invention has been explained in relation to various embodiments, it is to be understood that various modifications thereof will be apparent to those skilled in the art upon reading the specification. The features of the various embodiments of the articles described herein may be combined within an article. Therefore, it is to be understood that the invention described herein is intended to cover such modifications as fall within the scope of the appended claims.

1. A composite comprising:
at least two fiber sheets, each sheet comprising flame resistant fibers; and
at least one active chemical layer present between the fiber sheets;
wherein the fiber sheets are mechanically bonded to contain the active chemical between the fiber sheets.

2. The composite of claim 1 comprising:
at least three fiber sheets, each sheet comprising flame resistant fibers; and
at least two active chemical layers, present between the fiber sheets;
wherein the fiber sheets are mechanically bonded to contain the active chemical between the fiber sheets.

3. The composite of claim 1, wherein the composite is a flame barrier or a heat barrier.

4. The composite of claim 1, wherein the flame resistant fibers comprise oxidized polyacrylonitrile fibers.

5. The composite of claim 1, wherein the fiber sheets are nonwoven sheets.

6. The composite of claim 4, wherein the fiber sheet further comprises flame resistant fibers of a second type.

7. The composite of claim 6 wherein the second type of flame resistant fibers is chosen from among meta-aramids, para-aramids, poly(diphenylether para-aramid), polybenzimidazole, polyimides, polyamideimides, novoloids, poly(p-phenylene benzobisoxazoles), poly(p-phenylene benzothiazoles), flame retardant viscose rayon, polyetheretherketones, polyketones, polyetherimides, and combinations thereof.

8. The composite of claim 1, wherein the fiber sheet further comprises high temperature reinforcing fibers chosen from among glass fiber, mineral fiber, ceramic fiber, carbon fiber, stainless steel fiber and combinations thereof.

9. The composite of claim 1, wherein active chemical layer or layers comprise a heat absorbing intumescent or endothermic compound.

10. The composite of claim 9, wherein the endothermic compound comprises a mineral hydrate material chosen from among aluminum sulfate hexadecahydrate, alumina trihydrate, aluminum potassium sulfate dodecahydrate, magnesium sulfate heptahydrate, magnesium chloride hexahydrate, sodium tetraborate decahydrate and combinations thereof.

11. The composite of claim 1, wherein the fiber sheet further comprises a low temperature resistant fiber type chosen from among wood pulp types, hemps, flax, cottons, wools, nylons, polyesters, polyolefins, rayons, acrylics, silks, mohair, cellulose acetate, polylactides, lyocell, and combinations thereof.

12. The composite of claim 1, further comprising a reinforcing layer.

13. The composite of claim 1, further comprising an outer laminar material.

14. The composite of claim 13, wherein the outer laminar material comprises a polymeric film.

15. The composite of claim 14 wherein the polymeric film is chosen from among polyesters, polyethylenes, polypropylenes, polyvinyl chlorides, polyvinyl alcohols and combinations thereof.

16. The composite of claim 13, wherein the outer laminar material comprises metal foil.

17. The composite of claim 13, wherein the outer laminar material comprises paper.

18. The composite of claim 1, wherein the fiber sheets are mechanically bonded by needlepunching, quilting or stitchbonding.

19. The composite of claim 18, wherein the fiber sheets are mechanically bonded by needlepunching.

20. The composite of claim 1, wherein the composite is substantially free of organic binder and resin materials.

21. The composite of claim 1 having a fire rating of 1 hr, 1.5 hr, 2 hr, 2.5 hr, 3 hr and 4 hr when tested according to ASTM E-119.

22. A gypsum wallboard installation comprising the composite of claim 1.

23. A process for making a composite flame barrier, the process comprising:
providing a first nonwoven textile sheet, the nonwoven textile sheet comprising flame resistant fibers;
depositing an active chemical layer of at least one heat absorbing or endothermic compound onto the first nonwoven textile sheet;
overlaying a second nonwoven textile sheet onto the active chemical layer, the second nonwoven textile sheet comprising flame resistant fibers;
mechanically bonding the first and second nonwoven textile sheets together;
wherein the active chemical layer is mechanically contained within the first and second nonwoven textile sheets.

24. A process for making a composite flame barrier, the process comprising:
providing a first nonwoven textile sheet, the nonwoven textile sheet comprising flame resistant fibers;
depositing a first active chemical layer of at least one heat absorbing or endothermic compound onto the first nonwoven textile sheet;
overlaying a second, intermediate nonwoven textile sheet onto the first active chemical layer, the intermediate nonwoven textile sheet comprising flame resistant fibers;
depositing a second active chemical layer of at least one heat absorbing or endothermic compound onto the second, intermediate textile sheet;
overlaying a third nonwoven textile sheet onto the second active chemical layer, the third nonwoven textile sheet comprising flame resistant fibers; and
mechanically bonding the first, second and third nonwoven textile sheets together;
wherein the first and second active chemical layers are mechanically contained within the first, second and third nonwoven textile sheets.

25. The process of claim 23 wherein the flame resistant fibers comprise oxidized polyacrylonitrile fibers.

26. The process of claim 23, wherein the active chemical layer comprises a mineral hydrate material chosen from among aluminum sulfate hexadecahydrate, alumina trihydrate, aluminum potassium sulfate dodecahydrate, magnesium sulfate heptahydrate, magnesium chloride hexahydrate, sodium tetraborate decahydrate and combinations thereof.

27. The process of claim 24, wherein the first and second active chemical layers comprise a mineral hydrate material chosen from among aluminum sulfate hexadecahydrate, alumina trihydrate, aluminum potassium sulfate dodecahydrate, magnesium sulfate heptahydrate, magnesium chloride hexahydrate, sodium tetraborate decahydrate and combinations thereof.

28. The process of claim 23, wherein the fiber sheets further comprise flame resistant fibers of a second type.

29. The process of claim 28, wherein the second type of flame resistant fibers is chosen from among meta-aramids, para-aramids, poly(diphenylether para-aramid), polybenzimidazole, polyimides, polyamideimides, novoloids, poly(p-phenylene benzobisoxazoles), poly(p-phenylene benzothiazoles), flame retardant viscose rayon, polyetheretherketones, polyketones, polyetherimides, and combinations thereof.

30. The process of claim 23, wherein the fiber sheets are mechanically bonded by needlepunching.

31. The process of claim 23, wherein the composite flame barrier is substantially free of organic binder and resin materials.
